(19) United States
(12) Patent Application Publication
(10) Pub. No.: US 2018/0009179 A1
(43) Pub. Date: Jan. 11, 2018

(54) ADDITIVE MANUFACTURING APPARATUS

(71) Applicant: FUJI XEROX Co., Ltd., Tokyo (JP)

(72) Inventors: Torahiko KANDA, Kanagawa (JP); Motohiko SAKAMAKI, Kanagawa (JP)

(73) Assignee: FUJI XEROX Co., Ltd., Tokyo (JP)

(21) Appl. No.: 15/621,194

(22) Filed: Jun. 13, 2017

(30) Foreign Application Priority Data
Jul. 7, 2016 (JP) 2016-135263
Apr. 14, 2017 (JP) 2017-080670

(51) Int. Cl. B29C 71/04

(52) U.S. Cl. CPC B29C 71/04; B33Y 30/00

(57) ABSTRACT

An additive manufacturing apparatus includes a table, an ejecting unit that faces the table and ejects photocurable droplets toward the table, a light-applying unit that applies light to and cures the droplets on the table, a moving unit that moves the table back and forth along with the light-applying unit and relative to the ejecting unit, and a controller that controls the ejecting unit, the light-applying unit, and the moving unit such that the ejecting unit ejects droplets toward the table while the table is moved relative to the ejecting unit; the light-applying unit applies, when a direction of relative movement of the table is changed, light to the droplets that have moved together with the table out of an area where the table faces the ejecting unit; and a three-dimensional object is formed as a stack of layers composed of the droplets that have been cured.

### CROSS-REFERENCE TO RELATED APPLICATIONS

This application is based on and claims priority under 35 USC 119 from Japanese Patent Application No. 2016-135263 filed Jul. 7, 2016 and Japanese Patent Application No. 2017-080670 filed Apr. 14, 2017.

### BACKGROUND

### Technical Field

The present invention relates to an additive manufacturing apparatus.

### SUMMARY

According to an aspect of the invention, there is provided an additive manufacturing apparatus including a table, an ejecting unit that faces the table and ejects photocurable droplets toward the table, a light-applying unit that applies light to and cures the droplets ejected from the ejecting unit and landed on the table, a moving unit that moves the table back and forth along with the light-applying unit and relative to the ejecting unit, and a controller that controls the ejecting unit, the light-applying unit, and the moving unit such that the ejecting unit ejects droplets and makes the droplets land on the table while the table is moved relative to the ejecting unit; the light-applying unit applies, when a direction of relative movement of the table is changed, light to the droplets that have moved together with the table out of an area where the table faces the ejecting unit; and a three-dimensional object is formed as a stack of layers composed of the droplets that have been cured.

### BRIEF DESCRIPTION OF THE DRAWINGS

Exemplary embodiments of the present invention will be described in detail based on the following figures, wherein:

FIG. 1 is a schematic diagram (a front view) of an additive manufacturing apparatus according to a first exemplary embodiment that is forming a three-dimensional object;

FIG. 2 is another schematic diagram (a top view) of the additive manufacturing apparatus according to the first exemplary embodiment;

FIG. 3A is a schematic diagram (a front view) of the additive manufacturing apparatus according to the first exemplary embodiment that is forming a three-dimensional object, with a table being at a first position P1;

FIG. 3B is a schematic diagram (a front view) of the additive manufacturing apparatus according to the first exemplary embodiment that is forming a three-dimensional object, with the table having been moved to a third position P3 from the first position P1;

FIG. 3C is a schematic diagram (a front view) of the additive manufacturing apparatus according to the first exemplary embodiment that is forming a three-dimensional object, with the table having been moved to a fifth position P5 from the third position P3;

FIG. 3D is a schematic diagram (a front view) of the additive manufacturing apparatus according to the first exemplary embodiment that is forming a three-dimensional object, with the table having been moved to the third position P3 from the fifth position P5;

FIG. 3E is a schematic diagram (a front view) of the additive manufacturing apparatus according to the first exemplary embodiment that is forming a three-dimensional object, with the table having been moved to the first position P1 from the third position P3;

FIG. 4 is a timing chart illustrating the timings of operation of forming layers that is performed by moving the table of the additive manufacturing apparatus according to the first exemplary embodiment back and forth;

FIG. 5 is a schematic diagram (a front view) of an additive manufacturing apparatus according to a first comparative embodiment that is forming a three-dimensional object;

FIG. 6 is a schematic diagram (a front view) of an additive manufacturing apparatus according to a modification of the first exemplary embodiment (a first modification) that is forming a three-dimensional object;

FIG. 7 is a schematic diagram (a front view) of an additive manufacturing apparatus according to another modification of the first exemplary embodiment (a second modification) that is forming a three-dimensional object;

FIG. 8 is a schematic diagram (a front view) of an additive manufacturing apparatus according to yet another modification of the first exemplary embodiment (a third modification) that is forming a three-dimensional object;

FIG. 9 is a schematic diagram (a front view) of an additive manufacturing apparatus according to a second exemplary embodiment that is forming a three-dimensional object;

FIG. 10 is a schematic diagram (a side view) of a light-applying unit included in the additive manufacturing apparatus according to the second exemplary embodiment that is applying light to droplets landed on the table;

FIG. 11 is a schematic diagram (a side view) of a light-applying unit included in an additive manufacturing apparatus according to a modification of the second exemplary embodiment (a fourth modification) that is applying light to droplets landed on the table;

FIG. 12 is a schematic diagram (a side view) of a light-applying unit included in an additive manufacturing apparatus according to another modification of the second exemplary embodiment (a fifth modification) that is applying light to droplets landed on the table;

FIG. 13 is a schematic diagram (a side view) of a light-applying unit included in an additive manufacturing apparatus according to yet another modification of the second exemplary embodiment (a sixth modification) that is applying light to droplets landed on the table;

FIG. 14 is a schematic diagram (a side view) of a light-applying unit included in an additive manufacturing apparatus according to yet another modification of the second exemplary embodiment (a seventh modification) that is applying light to droplets landed on the table; and

FIG. 15 is a schematic diagram (a side view) of a light-applying unit included in an additive manufacturing apparatus according to yet another modification of the second exemplary embodiment (an eighth modification) that is applying light to droplets landed on the table.

### DETAILED DESCRIPTION

### Outline

The following exemplary embodiments of the present invention include a first exemplary embodiment and modifications thereof (first to third modifications), and a second exemplary embodiment and modifications thereof (fourth to eighth modifications). Directions in the drawings to be referred to in the following description are defined as follows: The +/−Z direction corresponds to the apparatus-height direction (the Z side corresponds to the upper side, and the −Z side corresponds to the lower side), the +/−X direction corresponds to the apparatus-width direction (the X side is referred to as the first side, and the −X side is referred to as the second side), and the direction (the +/−Y direction) intersecting the +/−Z direction and the +/−X direction corresponds to the apparatus-depth direction (the Y side corresponds to the far side, and the -Y side corresponds to the near side).

### First Exemplary Embodiment

An additive manufacturing apparatus 10 according to a first exemplary embodiment will now be described with reference to associated drawings. The description starts with a configuration of the additive manufacturing apparatus 10 according to the first exemplary embodiment, followed by a method of additively manufacturing an object M by using the additive manufacturing apparatus 10 according to the first exemplary embodiment, further followed by functions exerted by the first exemplary embodiment.

### Configuration

The additive manufacturing apparatus 10 according to the first exemplary embodiment forms a three-dimensional object VM by ejecting first droplets D1 and second droplets D2, which will be described later, toward a table BD and stacks layers LR each composed of the first droplets D1 and the second droplets D2 that have been cured. The technical meaning of the first droplets D1 and the second droplets D2 will be described later. Hereinafter, if there is no need to distinguish the first droplets D1 and the second droplets D2 from each other, the first droplets D1 and the second droplets D2 are collectively denoted as droplets D.

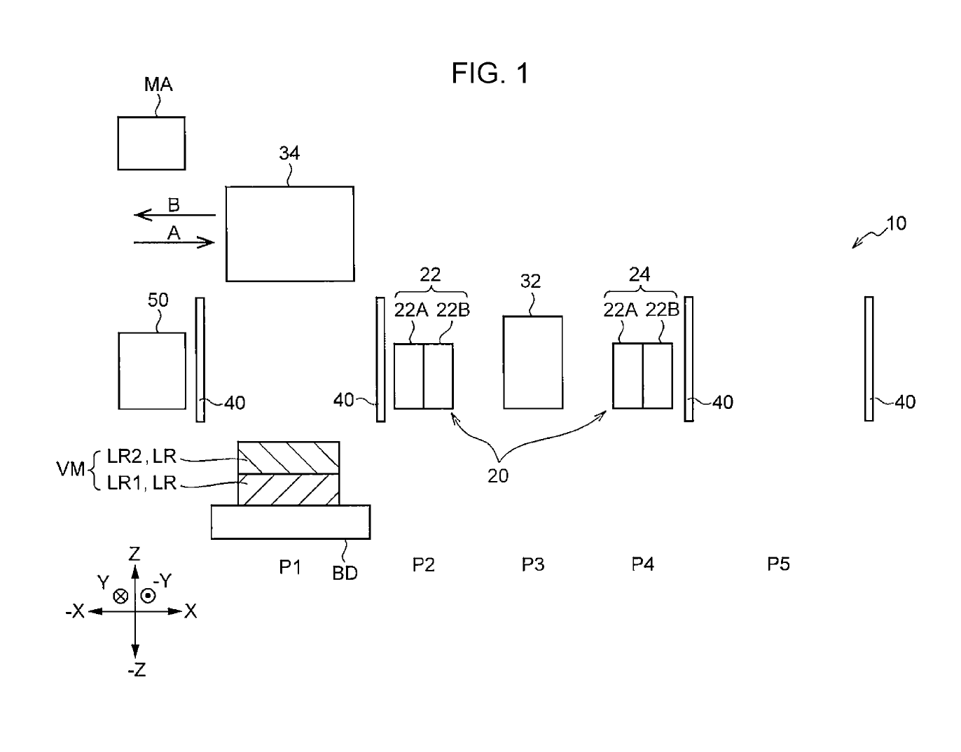

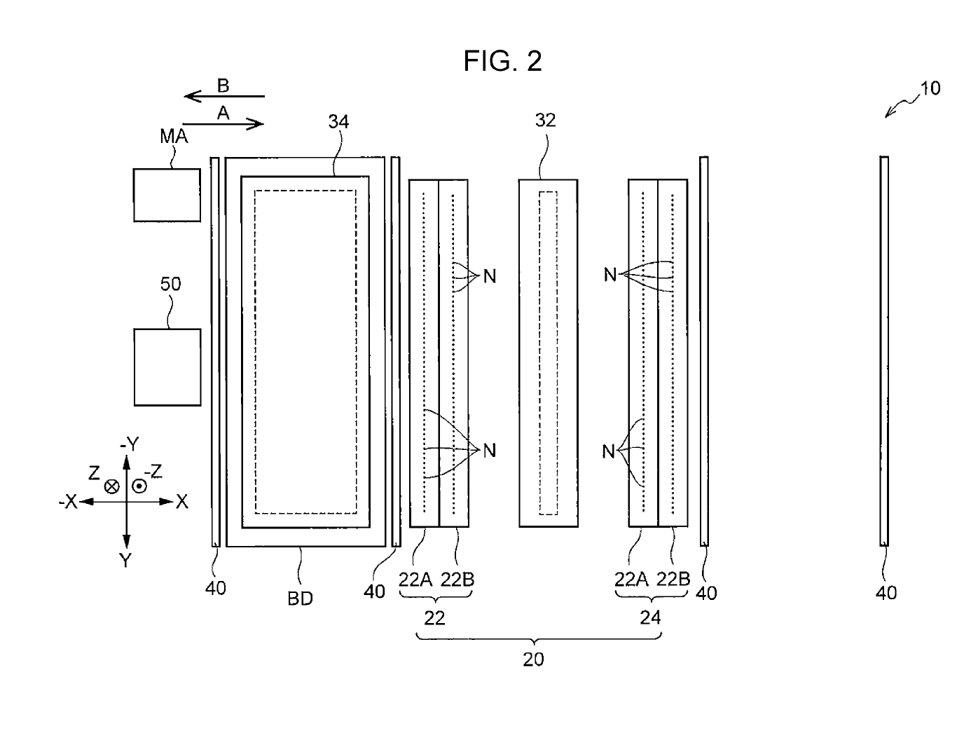

Referring to FIGS. 1 and 2, the additive manufacturing apparatus 10 includes the table BD, a moving device MA, an ejecting device 20, a first light-applying device 32, a second light-applying device 34, plural shutters 40, and a controller 50. The moving device MA is an exemplary moving unit. The ejecting device 20 is an exemplary ejecting unit. The second light-applying device 34 is an exemplary light-applying unit. The shutters 40 are exemplary reducing walls.

### Table

As illustrated in FIGS. 1 and 2, the table BD is a plate whose upper surface extends in the apparatus-width direction and in the apparatus-depth direction. A three-dimensional object VM is to be manufactured on the upper surface of the table BD.

### Moving Device

The moving device MA moves the table BD and the second light-applying device 34 relative to the ejecting device 20 back and forth in the apparatus-width direction. In other words, the moving device MA causes the table BD to move together with the second light-applying device 34 back and forth relative to the ejecting device 20. The moving device MA is also capable of moving the table BD back and forth in the apparatus-height direction independently of the second light-applying device 34.

To move the second light-applying device 34 and the table BD back and forth in the apparatus-width direction, the moving device MA includes guide rails (not illustrated) that allow the second light-applying device 34 and the table BD to move in the apparatus-width direction, a drive source that generates a driving force, and belts (not illustrated) that transmit the driving force to the second light-applying device 34 and to the table BD. To move the table BD in the apparatus-height direction, the moving device MA includes a guide rail (not illustrated) that allows the table BD to move in the apparatus-height direction, another drive source that generates a driving force, and a belt (not illustrated) that transmits the driving force to the table BD.

In each of the drawings, arrow A represents a direction of forward movement of the table BD (the direction is hereinafter referred to as the forward direction), and arrow B represents a direction of backward movement of the table BD (the direction is hereinafter referred to as the backward direction).

### Ejecting Device

As illustrated in FIGS. 1 and 2, the ejecting device 20 includes a first ejecting unit 22 and a second ejecting unit 24. The ejecting device 20 ejects droplets D from the first ejecting unit 22 and from the second ejecting unit 24 toward the table BD that is moving relative to the ejecting device 20. The first ejecting unit 22 and the second ejecting unit 24 are other exemplary ejecting units. At certain timings, the first ejecting unit 22 and the second ejecting unit 24 face the table BD that is moving relative thereto.

### First Ejecting Unit

The first ejecting unit 22 includes a first head 22A and a second head 22B. The first head 22A ejects droplets D composed of a model material. The second head 22B ejects droplets D composed of a support material. The model material and the support material according to the first exemplary embodiment each contain photocurable resin (in the first exemplary embodiment, an ultraviolet-curable resin, for example). When light (ultraviolet light, for example) is applied to the droplets D composed of the model material and the support material according to the first exemplary embodiment, the droplets D are cured to such an extent as to form a layer LR.

Herein, the term “model material” refers to a material that forms an object M to be manufactured by using the additive manufacturing apparatus 10, and the term “support material” refers to a material that forms, if necessary, a three-dimensional object VM in combination with the model material in the process of additively manufacturing an object M but does not form the object M. In the first exemplary embodiment, a three-dimensional object VM is first manufactured by the additive manufacturing apparatus 10, the three-dimensional object VM is then detached from the additive manufacturing apparatus 10, and the support material is lastly removed from the three-dimensional object VM by an operator.

The first head 22A and the second head 22B have substantially the same configuration, except the materials composing the droplets D to be ejected therefrom. As illustrated in FIG. 2, the first head 22A and the second head 22B each have a long shape and are arranged side by side in that order in the apparatus-width direction from the second side.

As illustrated in FIG. 1, the first head 22A has a flat surface that faces the table BD. The flat surface of the first head 22A has plural nozzles N from which droplets D are ejected. As illustrated in FIG. 2, the plural nozzles N are aligned in the apparatus-depth direction at regular intervals. The nozzles N are exemplary ejection ports.

The second head 22B and the first head 22A are in contact with each other at respective surfaces that face each other in the short-side direction thereof. More specifically, the second head 22B is positioned such that the nozzles N thereof all coincide with all of the nozzles N of the first head 22A, respectively, in the apparatus-width direction.

In the above configuration, when the first ejecting unit 22 ejects droplets D toward the table BD that is moving in the apparatus-width direction, the droplets D land on the table BD in such a manner as to be spaced apart from one another in the apparatus-depth direction (not illustrated). The second head 22B is controlled by the controller 50 to eject droplets D such that those droplets D do not overlap, in the apparatus-width direction, the droplets D already ejected from the first head 22A and landed on the table BD.

### Second Ejecting Unit

The second ejecting unit 24 includes a first head 22A and a second head 22B. As with the case of the first ejecting unit 22, the first head 22A and the second head 22B included in the second ejecting unit 24 eject droplets D composed of a model material and droplets D composed of a support material, respectively.

As illustrated in FIG. 2, the first head 22A and the second head 22B included in the second ejecting unit 24 are arranged side by side in that order in the apparatus-width direction from the second side.

As with the case of the first ejecting unit 22, the first head 22A and the second head 22B included in the second ejecting unit 24 are arranged such that nozzles N of the second head 22B all coincide with all nozzles N of the first head 22A, respectively, in the apparatus-width direction.

The second ejecting unit 24 is shifted from the first ejecting unit 22 in the apparatus-depth direction by half a pitch of the nozzles N.

In the above configuration, the second ejecting unit 24 ejects droplets D toward the table BD that is moving in the apparatus-width direction such that the droplets D each land on a position between adjacent ones of the droplets D already ejected from the first ejecting unit 22 and landed on the table BD. As with the case of the first ejecting unit 22, the second head 22B of the second ejecting unit 24 is controlled by the controller 50 to eject droplets D such that those droplets D do not overlap, in the apparatus-width direction, the droplets D already ejected from the first head 22A and landed on the table BD.

### First Light-Applying Device

The first light-applying device 32 applies light (for example, ultraviolet light) to and cures the droplets D ejected from the ejecting device 20 and landed on the table BD. As illustrated in FIGS. 1 and 2, the first light-applying device 32 has a long shape, with the long-side direction thereof corresponding to the apparatus-depth direction, and is provided between the first ejecting unit 22 and the second ejecting unit 24 in the apparatus-width direction. Referring to FIG. 2, an area of the first light-applying device 32 that is enclosed by a broken line represents a light-emitting area of the first light-applying device 32.

### Second Light-Applying Device

The second light-applying device 34 moves along with the table BD back and forth in the apparatus-width direction relative to the ejecting device 20 and, when the direction of relative movement of the table BD is changed, applies light (for example, ultraviolet light) to the droplets D that have moved together with the table BD out of an area where the table BD faces one of the first ejecting unit 22 and the second ejecting unit 24.

As illustrated in FIGS. 1 and 2, the second light-applying device 34 has a long shape and faces the table BD, with the long-side direction thereof corresponding to the apparatus-depth direction. The second light-applying device 34 is moved back and forth in the apparatus-width direction by the moving device MA in such a manner as to keep facing the table BD. Referring to FIG. 2, an area of the second light-applying device 34 that is enclosed by a broken line represents a light-emitting area of the second light-applying device 34.

In FIG. 1, the position (a position P1) in the apparatus-width direction where the second light-applying device 34 is illustrated is one of two positions where the direction of movement of the table BD that is moved back and forth is changed. The second light-applying device 34 is controlled by the controller 50 to apply, at the position P1, light to droplets D ejected from the first ejecting unit 22 and landed on the table BD. A position P5 illustrated in FIG. 1 is the other of the two positions where the direction of movement of the table BD that is moved back and forth is changed.

### Shutters

The plural shutters 40 each reduce the quantity of light traveling toward the plural nozzles N of the first ejecting unit 22 or the second ejecting unit 24 after being emitted from the second light-applying device 34 and reflected by the droplets D on the table BD.

As illustrated in FIGS. 1 and 2, the plural shutters 40 include two pairs of shutters 40 that are provided on two respective outer sides of the ejecting device 20 in the apparatus-width direction. The shutters 40 are each a long plate and is positioned with the thickness direction thereof corresponding to the apparatus-width direction and with the long-side direction thereof corresponding to the apparatus-depth direction. Each pair of shutters 40 face each other at an interval longer than the length of the second light-applying device 34 in the apparatus-width direction. The lower end of each of the shutters 40 in the apparatus-height direction projects downward beyond the first ejecting unit 22 and the second ejecting unit 24.

In the above configuration, when the second light-applying device 34 applies light to the droplets D on the table BD, one of each pair of shutters 40 that is nearer to the center in the apparatus-width direction reduces the quantity of light traveling toward the plural nozzles N after being emitted from the second light-applying device 34 and reflected by the droplets D.

### Controller

The controller 50 receives data from an external apparatus and converts information on a three-dimensional object VM contained in the received data into layer data provided for forming layers LR as slices of the three-dimensional object VM that are taken along planes perpendicular to the apparatus-height direction at intervals each corresponding to a predetermined thickness. The controller 50 also controls the ejecting device 20, the first light-applying device 32, the second light-applying device 34, and the moving device MA in accordance with the data received from the external apparatus. Consequently, the controller 50 causes the ejecting device 20, the first light-applying device 32, the second light-applying device 34, and the moving device MA to form the three-dimensional object VM as a stack of layers of cured droplets D in accordance with the information on the three-dimensional object VM. Specific operations of the controller 50 will further be described in the following description of a method of additively manufacturing an object M.

### Method of Additively Manufacturing Object According to First Exemplary Embodiment

Now, a method of additively manufacturing an object M by using the additive manufacturing apparatus 10 according to the first exemplary embodiment will be described with reference to associated drawings.

### Converting Data

When the controller 50 receives data from an external apparatus, the controller 50 converts information on a three-dimensional object VM contained in the received data into layer data provided for forming layers LR as slices of the three-dimensional object VM that are taken along planes perpendicular to the apparatus-height direction at intervals each corresponding to a predetermined thickness.

### Forming First Layer

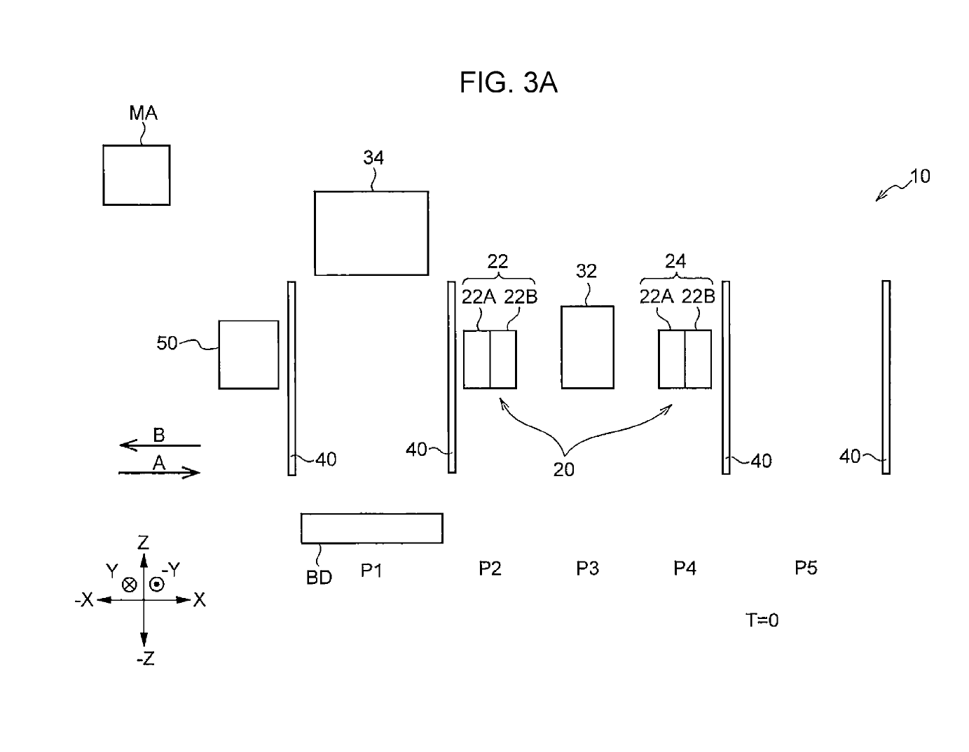

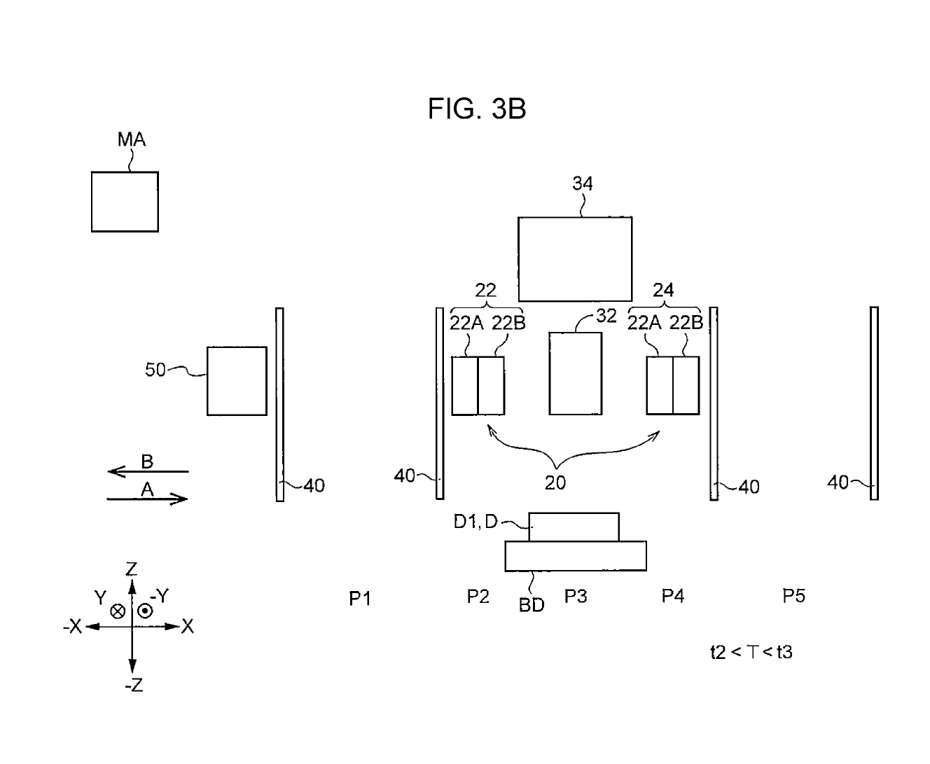

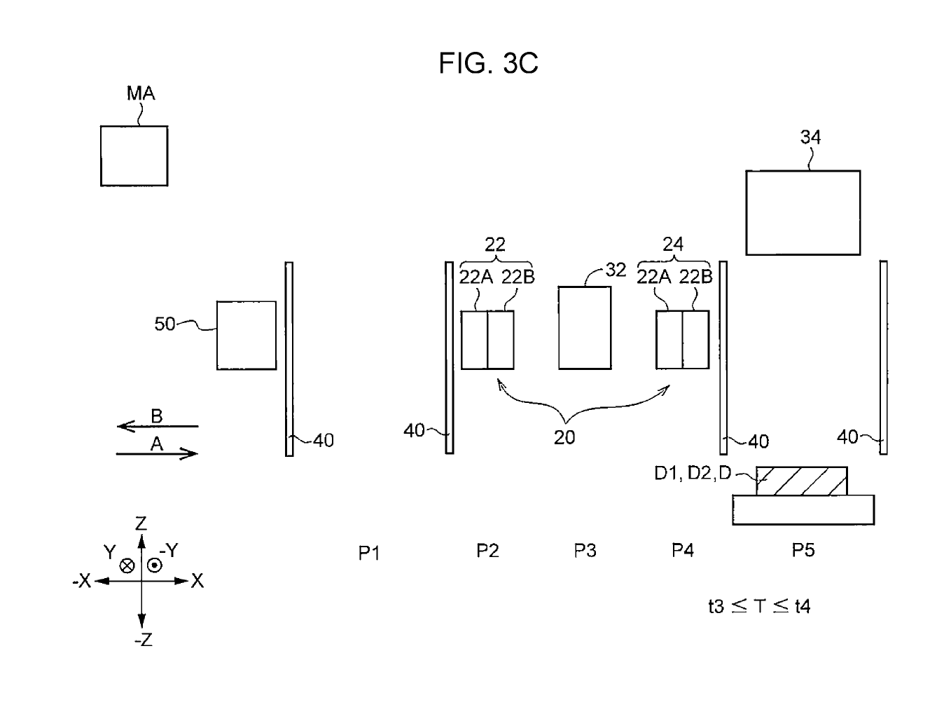

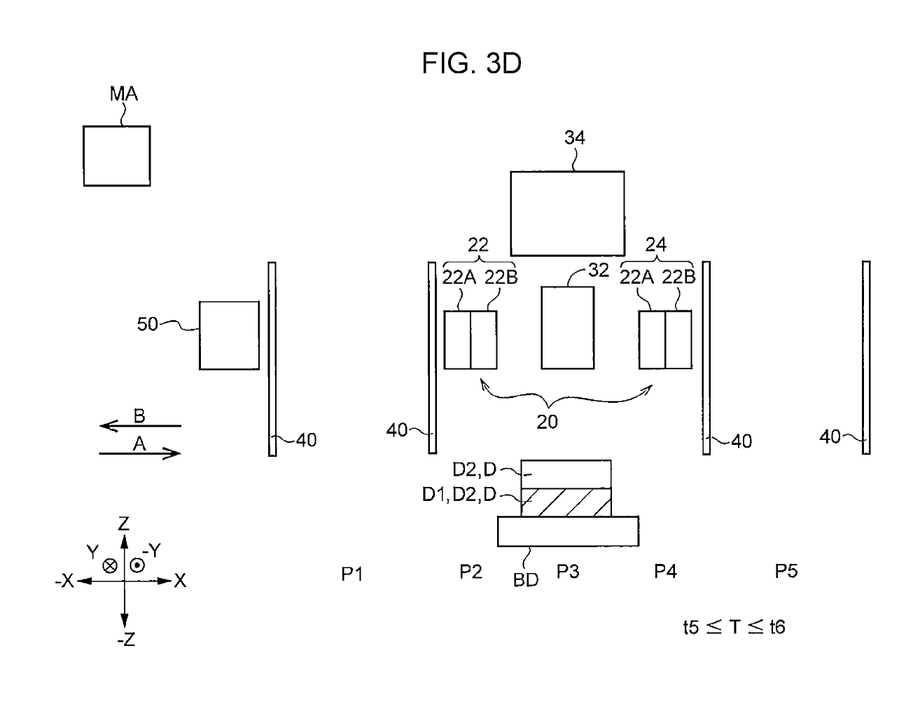

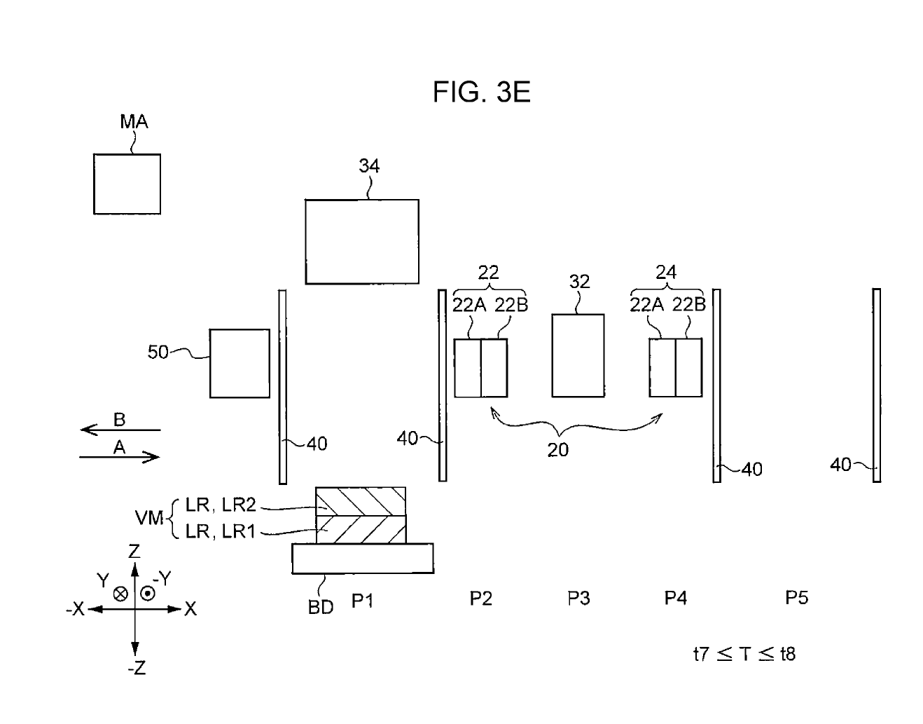

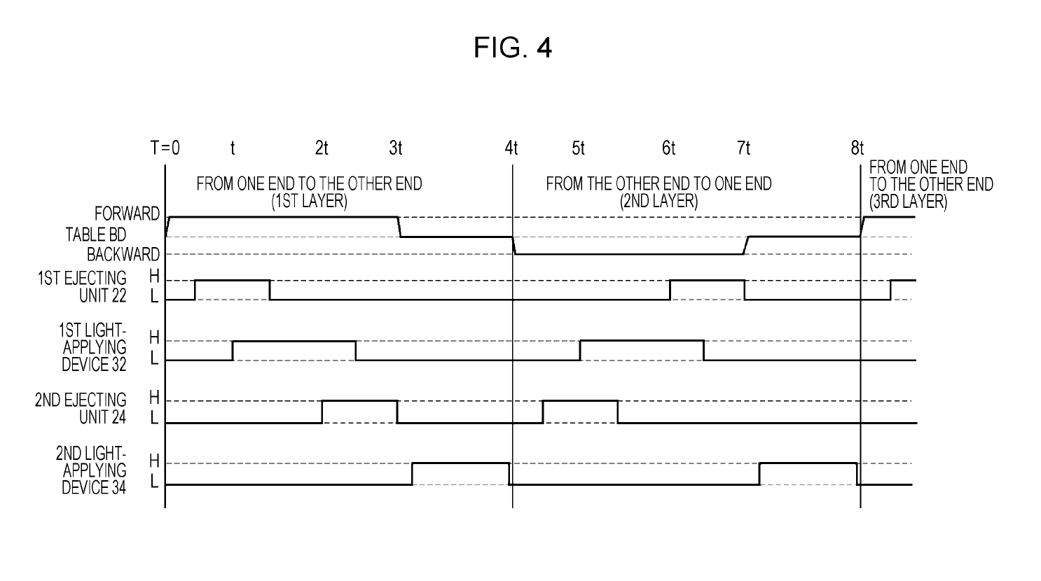

Subsequently, the controller 50 forms a first layer LR1 by using the ejecting device 20, the first light-applying device 32, the second light-applying device 34, and the moving device MA in accordance with a first piece of layer data included in the layer data obtained by the above conversion. Specifically, while the controller 50 moves the table BD in the forward direction from the position P1 (defined as the home position), the controller 50 causes the first ejecting unit 22 to eject first droplets D1 toward the table BD having reached a position P2 (see FIGS. 3A and 3B and FIG. 4). Subsequently, while moving the table BD further forward, the controller 50 activates the first light-applying device 32 and causes the first light-applying device 32 to apply light to the first droplets D1 on the table BD having reached a position P3 (see FIG. 3B and FIG. 4). Consequently, the first droplets D1 on the table BD are cured with the light. Subsequently, while moving the table BD further forward, the controller 50 causes the second ejecting unit 24 to eject second droplets D2 toward spaces each between adjacent ones of the first droplets D1 on the table BD that has arrived at a position P4. Subsequently, when the table BD moved in the forward direction by the moving device MA reaches the position P5, the controller 50 activates the second light-applying device 34 that has been moved along with the table BD and causes the second light-applying device 34 to apply light to the second droplets D2 (see FIG. 3C). Consequently, the second droplets D2 are cured with the light. The light emitted from the second light-applying device 34 is also applied to the first droplets D1. In the timing chart illustrated in FIG. 4, T represents time; the “forward” side of the chart for the table BD represents that the table BD is moving in the forward direction, whereas the “backward” side represents that the table BD is moving in the backward direction; and the “H” side of the chart for each of the first ejecting unit 22, the second ejecting unit 24, the first light-applying device 32, and the second light-applying device 34 represents that a corresponding one of the units and devices is in operation, whereas the “L” side represents that the corresponding unit or device is not in operation. At time t3 in an additive manufacturing process, the table BD reaches the position P5. During a period from time t3 to time t4, the second light-applying device 34 applies light to the table BD that is at the position P5.

Thus, when the controller 50 causes the moving device MA to move the table BD from a second-side end (the position P1) to a first-side end (the position P5) in the apparatus-width direction, that is, when the table BD reaches one of the two positions where the direction of movement of the table BD is changed, a layer LR (see the first layer LR1 illustrated in FIGS. 1 and 3E) composed of the first droplets D1 and the second droplets D2 that have been cured is formed on the table BD. After the controller 50 causes the moving device MA to move the table BD to the position P5, the controller 50 further causes the moving device MA to move the table BD downward in the apparatus-height direction by a length corresponding to the thickness of the layer LR. Then, the controller 50 ends the step of forming the first layer LR1.

### Forming Second and Subsequent Layers

Second and subsequent layers LR are formed by repeating the above step of forming the first layer LR1 after reversing the direction of movement of the table BD (see FIGS. 3A to 3E). When a stack of all layers LR is obtained in accordance with the layer data by the associated units and devices under the control of the controller 50, the controller 50 returns the table BD to the position P1 and ends the process of additively manufacturing the three-dimensional object VM by using the additive manufacturing apparatus 10 according to the first exemplary embodiment. After the process of additively manufacturing the three-dimensional object VM by using the additive manufacturing apparatus 10 ends, the operator detaches the three-dimensional object VM from the additive manufacturing apparatus 10. The operator then removes the cured support material from the three-dimensional object VM. Thus, an object M is obtained.

### Functions Exerted by First Exemplary Embodiment

Now, functions (first and second functions) exerted by the first exemplary embodiment will be described with reference to associated drawings.

### First Function

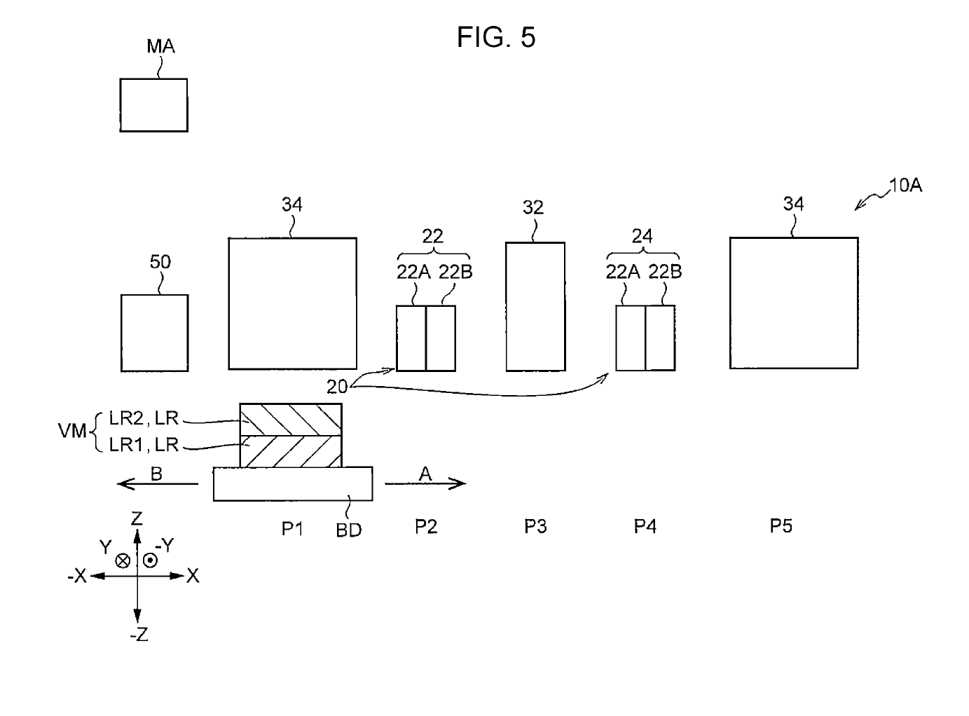

A first function is exerted by moving the second light-applying device 34 back and forth along with the table BD. The first function of the additive manufacturing apparatus 10 according to the first exemplary embodiment will be described in comparison with a function exerted by an additive manufacturing apparatus 10A according to a first comparative embodiment (see FIG. 5). In the following description, any elements of the additive manufacturing apparatus 10A according to the first comparative embodiment that are the same as those of the additive manufacturing apparatus 10 according to the first exemplary embodiment are denoted by corresponding ones of the reference numerals used for the additive manufacturing apparatus 10, whether they are illustrated or not.

The additive manufacturing apparatus 10A according to the first comparative embodiment (see FIG. 5) differs from the additive manufacturing apparatus 10 according to the first exemplary embodiment (see FIG. 1) in that the second light-applying device 34 does not move back and forth along with the table BD and in that the second light-applying device 34 is provided at each of the position P1 and the position P5. That is, the additive manufacturing apparatus 10A according to the first comparative embodiment includes two second light-applying devices 34. Furthermore, the additive manufacturing apparatus 10A according to the first comparative embodiment does not include any shutters 40. The other details of the first comparative embodiment are the same as those of the first exemplary embodiment.

In contrast, in the additive manufacturing apparatus 10 according to the first exemplary embodiment illustrated in FIGS. 1 and 2, the second light-applying device 34 moves back and forth along with the table BD and applies light to the droplets D on the table BD at each of the position P1 and the position P5.

Hence, the additive manufacturing apparatus 10 according to the first exemplary embodiment includes a smaller number of second light-applying devices 34 than an additive manufacturing apparatus including the second light-applying device 34 at each of the positions P1 and P5 where the direction of movement of the table BD relative to the ejecting device 20 is changed. In other words, the additive manufacturing apparatus 10 according to the first exemplary embodiment costs lower than an additive manufacturing apparatus including two second light-applying devices 34 at the respective positions P1 and P5 where the direction of movement of the table BD relative to the ejecting device 20 is changed.

### Second Function

A second function is exerted by including the shutters 40. The second function of the additive manufacturing apparatus 10 according to the first exemplary embodiment will now be described in comparison with a function exerted by the additive manufacturing apparatus 10A according to the first comparative embodiment (see FIG. 5).

The additive manufacturing apparatus 10A according to the first comparative embodiment (see FIG. 5) differs from the additive manufacturing apparatus 10 according to the first exemplary embodiment (see FIG. 1) in not including any shutters 40. Hence, in the first comparative embodiment, the light applied from the second light-applying device 34 to the droplets D and reflected by the droplets D may reach the plural nozzles N of the first ejecting unit 22 and the second ejecting unit 24. In such an event, droplets D in the nozzles N are cured, and the cured droplets D clog the nozzles N of the first ejecting unit 22 and the second ejecting unit 24.

In contrast, the additive manufacturing apparatus 10 according to the first exemplary embodiment illustrated in FIGS. 1 and 2 includes the plural shutters 40, specifically, two pairs of shutters 40 that are provided on two respective outer sides of the ejecting device 20 in the apparatus-width direction. Hence, when the second light-applying device 34 applies light to the droplets D on the table BD, one of each pair of shutters 40 that is nearer to the center in the apparatus-width direction reduces the quantity of light traveling toward the plural nozzles N after being emitted from the second light-applying device 34 and reflected by the droplets D.

Thus, in the additive manufacturing apparatus 10 according to the first exemplary embodiment, the probability that droplets D in the nozzles N may be cured is lower than in an additive manufacturing apparatus including no reducing walls that reduce the quantity of light traveling toward the nozzles N after being applied to and reflected by the droplets D.

### First Modification of First Exemplary Embodiment (First Modification)

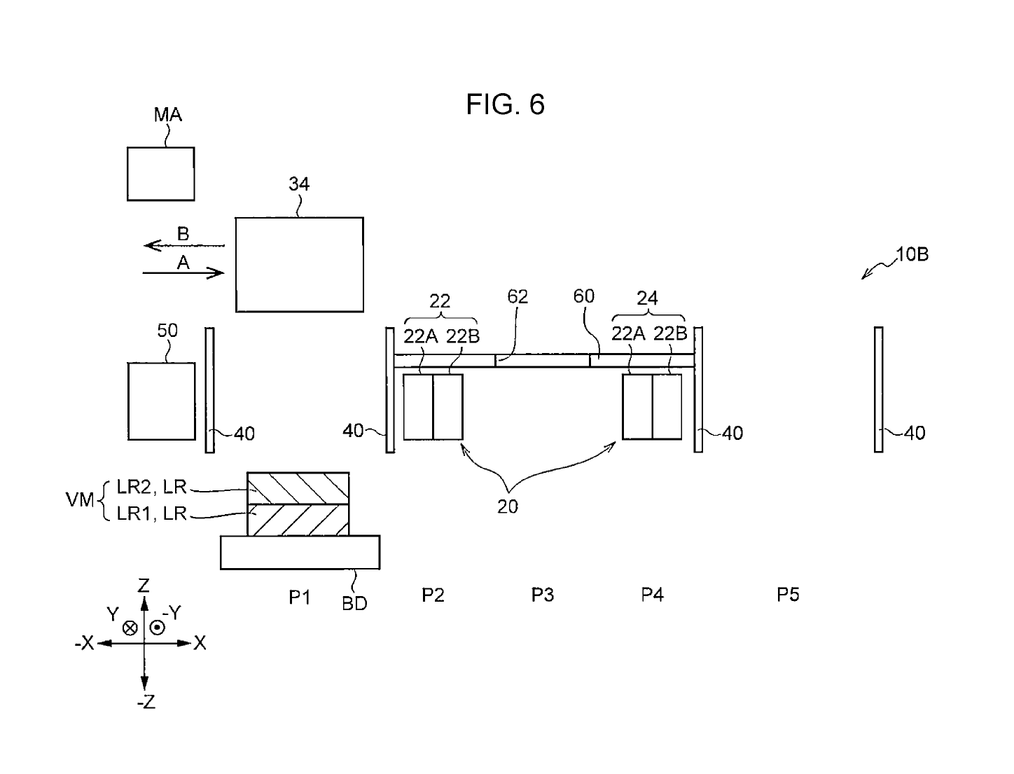

Now, an additive manufacturing apparatus 10B according to a first modification will be described with reference to FIG. 6. In the following description, any elements of the additive manufacturing apparatus 10B according to the first modification that are the same as those of the additive manufacturing apparatus 10 according to the first exemplary embodiment are denoted by corresponding ones of the reference numerals used for the additive manufacturing apparatus 10, whether they are illustrated or not.

### Configuration of Additive Manufacturing Apparatus and Method of Additively Manufacturing Object

The additive manufacturing apparatus 10B according to the first modification (see FIG. 6) differs from the additive manufacturing apparatus 10 according to the first exemplary embodiment (FIG. 1) in not including the first light-applying device 32. Instead, the additive manufacturing apparatus 10B according to the first modification includes a light-blocking plate 60 between two of the shutters 40 that are nearer to the center in the apparatus-width direction (the direction of relative movement of the table BD) and between the ejecting device 20 and the second light-applying device 34 in the apparatus-height direction. That is, the light-blocking plate 60 is provided across the ejecting device 20 from the table BD. The light-blocking plate 60 is an exemplary blocking member. The light-blocking plate 60 has a through hole 62 in the center thereof. Seen in the apparatus-height direction (the direction in which the first ejecting unit 22 or the second ejecting unit 24 and the table BD face each other), the light-blocking plate 60 extends over the entire area that covers the first ejecting unit 22 and the second ejecting unit 24. The through hole 62 is provided in a region of the light-blocking plate 60 that overlaps neither the first ejecting unit 22 nor the second ejecting unit 24. The other details of the additive manufacturing apparatus 10B according to the first modification are the same as those of the additive manufacturing apparatus 10 according to the first exemplary embodiment. A method of additively manufacturing an object M according to the first modification is the same as the method of additively manufacturing an object M according to the first exemplary embodiment, except that the second light-applying device 34 constantly emits light during the additive manufacturing process.

### Functions

Suppose that the light-blocking plate 60 is not provided. When the second light-applying device 34 emits light from a side across the first ejecting unit 22 and the second ejecting unit 24 from the table BD, the light emitted from the second light-applying device 34 may be reflected by the upper surface of the first ejecting unit 22 or the second ejecting unit 24 (or wiring lines or the like provided on the upper side of the first ejecting unit 22 and the second ejecting unit 24) and thus reach the table BD.

In contrast, in the additive manufacturing apparatus 10B according to the first modification, the light emitted from the second light-applying device 34 is blocked by the light-blocking plate 60 while the table BD is moving across the position P2 and across the position P4. Hence, in the additive manufacturing apparatus 10B according to the first modification, when the second light-applying device 34 emits light from the side across the first ejecting unit 22 and the second ejecting unit 24 from the table BD, the light from the second light-applying device 34 is less likely to reach the table BD. Accordingly, the quantity of light traveling toward the plural nozzles N after being reflected by the droplets D is small, and the probability that droplets D in the nozzles N may be cured is low.

Furthermore, in the additive manufacturing apparatus 10B according to the first modification, the light from the second light-applying device 34 is applied to the table BD through the through hole 62. Hence, the additive manufacturing apparatus 10B according to the first modification does not need the first light-applying device 32 (see FIG. 1). The other functions exerted by the first modification are the same as those exerted by the first exemplary embodiment.

### Second Modification of First Exemplary Embodiment (Second Modification)

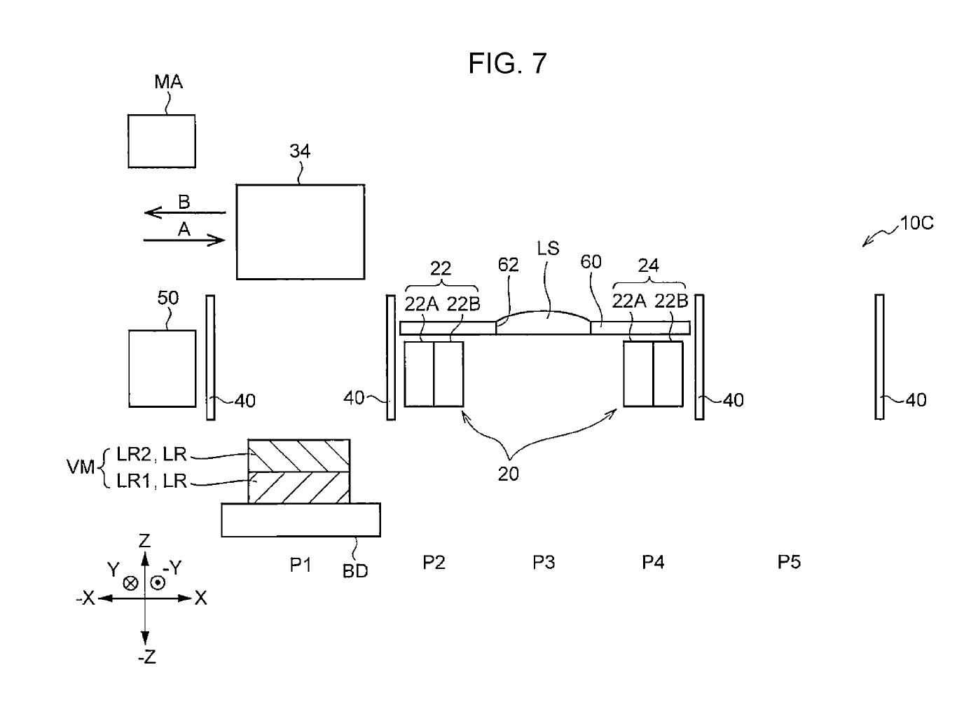

Now, an additive manufacturing apparatus 10C according to a second modification will be described with reference to FIG. 7. In the following description, any elements of the additive manufacturing apparatus 10C according to the second modification that are the same as those of the additive manufacturing apparatus 10 according to the first exemplary embodiment or the additive manufacturing apparatus 10B according to the first modification are denoted by corresponding ones of the reference numerals used for the additive manufacturing apparatus 10 or 10B, whether they are illustrated or not.

### Configuration of Additive Manufacturing Apparatus and Method of Additively Manufacturing Object

The additive manufacturing apparatus 10C according to the second modification (see FIG. 7) includes all of the elements included in the additive manufacturing apparatus 10B according to the first modification (see FIG. 6). The additive manufacturing apparatus 10C according to the second modification further includes a lens LS, which is not included in the additive manufacturing apparatus 10B according to the first modification. The lens LS is an exemplary focusing body. The lens LS is a convex lens and is fitted in the through hole 62 provided in the light-blocking plate 60. The lens LS focuses the light emitted from the second light-applying device 34 on the droplets D landed on the table BD. That is, the lens LS focuses the light on a side thereof where the table BD is provided. The other details of the second modification are the same as those of the first modification. In a method of additively manufacturing an object M according to the second modification, an object M is additively manufactured with the associated units and devices operating in the same manner as in the first modification.

### Functions

In the additive manufacturing apparatus 10C according to the second modification, the light emitted from the second light-applying device 34 is focused on the side of the lens LS where the table BD is provided. The other functions exerted by the second modification are the same as those exerted by the first exemplary embodiment or the first modification.

### Third Modification of First Exemplary Embodiment (Third Modification)

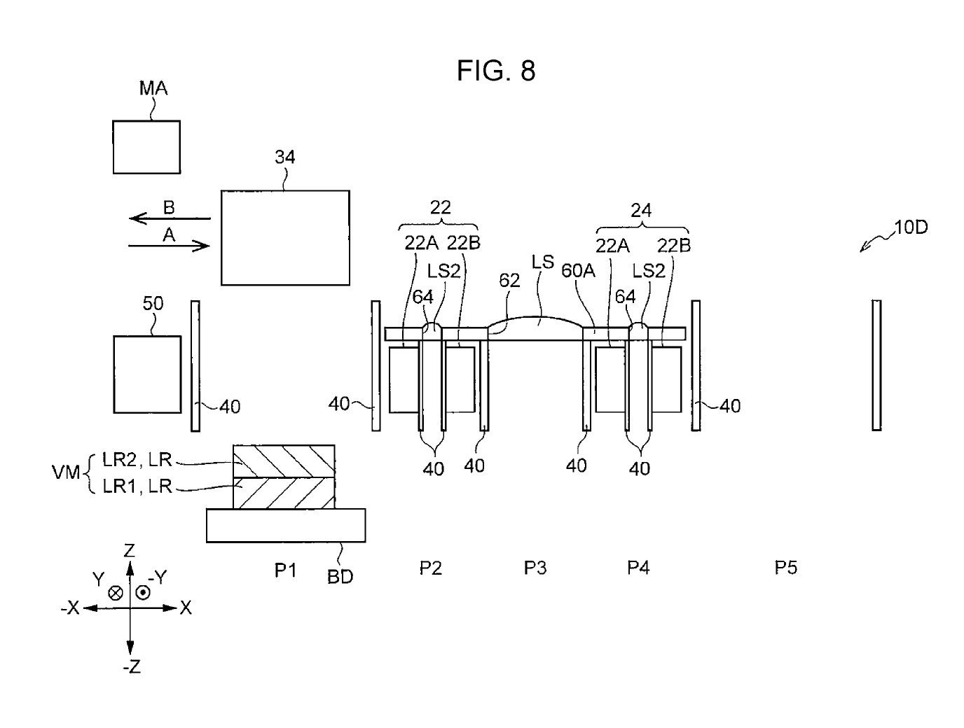

Now, an additive manufacturing apparatus 10D according to a third modification will be described with reference to FIG. 8. In the following description, any elements of the additive manufacturing apparatus 10D according to the third modification that are the same as those of the additive manufacturing apparatus 10 according to the first exemplary embodiment, the additive manufacturing apparatus 10B according to the first modification, or the additive manufacturing apparatus 10C according to the second modification are denoted by corresponding ones of the reference numerals used for any of the additive manufacturing apparatuses 10, 10B, and 10C, whether they are illustrated or not.

### Configuration of Additive Manufacturing Apparatus and Method of Additively Manufacturing Object

In the additive manufacturing apparatus 10D according to the third modification, the first head 22A and the second head 22B included in each of the first ejecting unit 22 and the second ejecting unit 24 are spaced apart from each other in the apparatus-width direction. Furthermore, the additive manufacturing apparatus 10D includes pairs of additional shutters 40 at the following positions: a pair of shutters 40 provided between the first ejecting unit 22 and the second ejecting unit 24 on respective outer sides of the lens LS when seen in the apparatus-height direction; and pairs of shutters 40 each provided between the first head 22A and the second head 22B of a corresponding one of the first ejecting unit 22 and the second ejecting unit 24. Furthermore, the additive manufacturing apparatus 10D according to the third modification includes a light-blocking plate 60A, which is a modification of the light-blocking plate 60 according to the first or second modification. The light-blocking plate 60A has through holes 64 at a position above the gap between the first head 22A and the second head 22B of the first ejecting unit 22 and at a position above the gap between the first head 22A and the second head 22B of the second ejecting unit 24, respectively. The through holes 64 are provided with lenses LS2 fitted therein. The lenses LS2 focus the light emitted from the second light-applying device 34 on the droplets D landed on the table BD, that is, on the side of the lenses LS2 where the table BD is provided. The light-blocking plate 60A is an exemplary blocking member. The lenses LS2 are exemplary focusing bodies. The other details of the third modification are the same as those of the second modification. In a method of additively manufacturing an object M according to the third modification, an object M is additively manufactured with the associated units and devices operating in the same manner as in the first or second modification.

### Functions

In the additive manufacturing apparatus 10D according to the third modification, the light emitted from the second light-applying device 34 is transmitted through the lenses LS2 and is thus focused on the side of the lenses LS2 where the table BD is provided. Furthermore, in the additive manufacturing apparatus 10D according to the third modification, the plural shutters 40 reduce the quantity of light traveling toward the plural nozzles N after being emitted from the second light-applying device 34 and reflected by the droplets D. The other functions exerted by the third modification are the same as those exerted by the first exemplary embodiment or the first or second modification.

### Second Exemplary Embodiment

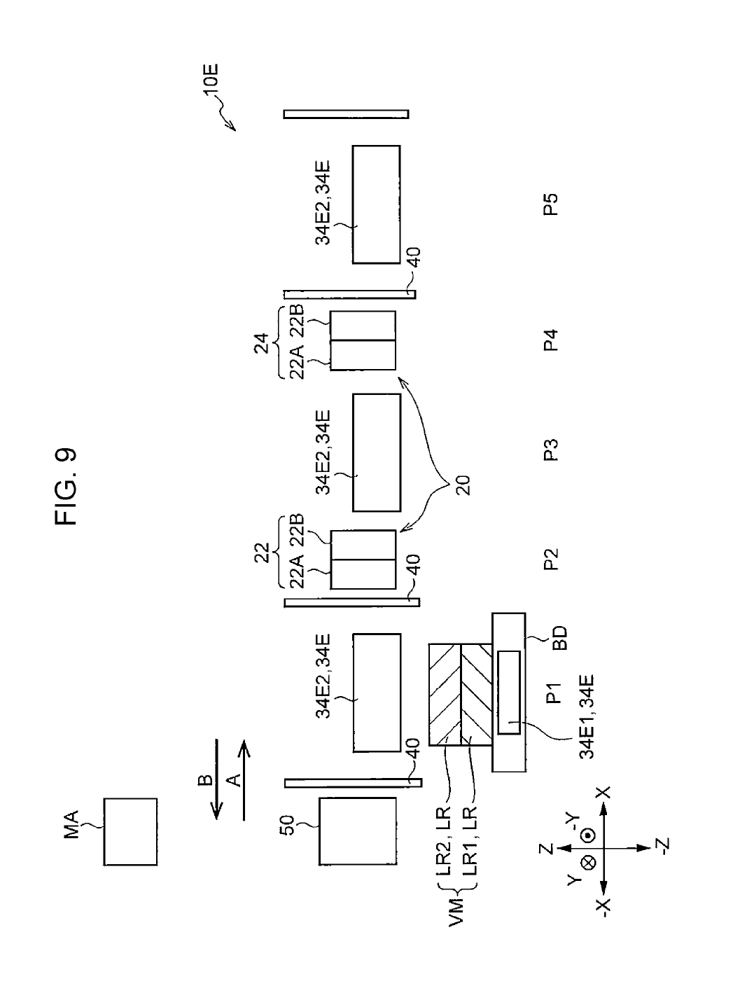

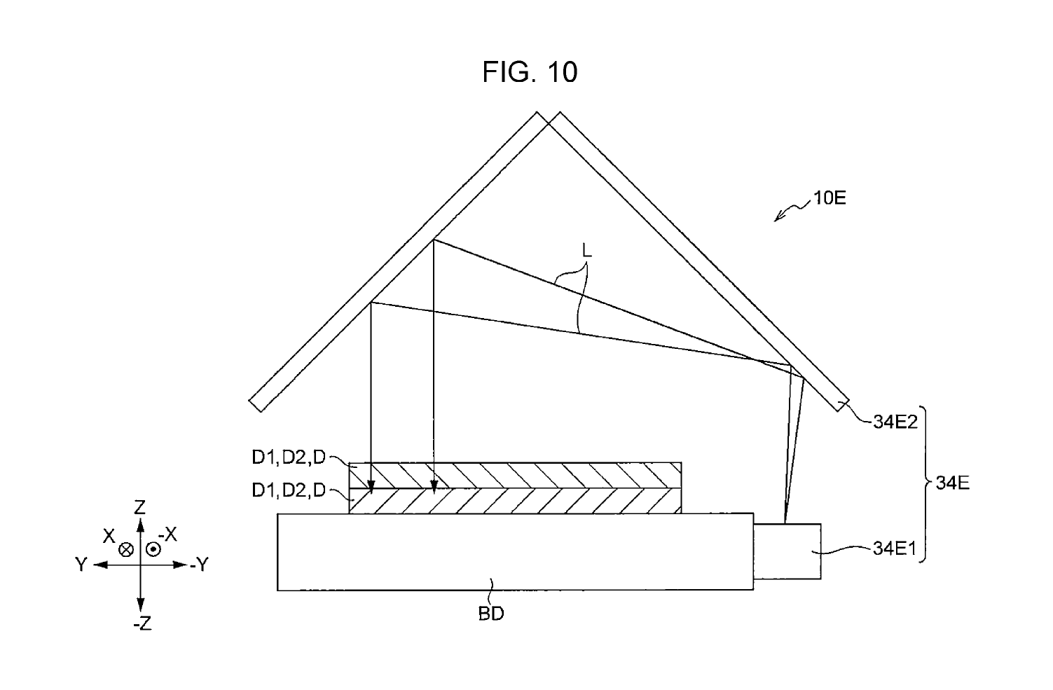

Now, an additive manufacturing apparatus 10E according to a second exemplary embodiment will be described with reference to FIGS. 9 and 10. In the following description, any elements of the additive manufacturing apparatus 10E according to the second exemplary embodiment that are the same as those of the additive manufacturing apparatus 10 according to the first exemplary embodiment or any of the additive manufacturing apparatuses 10B, 10C, and 10D according to the first to third modifications thereof are denoted by corresponding ones of the reference numerals used for any of the additive manufacturing apparatuses 10 and 10B to 10D, whether they are illustrated or not.

### Configuration of Additive Manufacturing Apparatus and Method of Additively Manufacturing Object

The additive manufacturing apparatus 10E according to the second exemplary embodiment (see FIGS. 9 and 10) does not include the first light-applying device 32 included in the additive manufacturing apparatus 10 according to the first exemplary embodiment (see FIG. 1). Furthermore, in replacement of the second light-applying device 34 included in the additive manufacturing apparatus 10 according to the first exemplary embodiment (see FIG. 1), the additive manufacturing apparatus 10E according to the second exemplary embodiment (see FIGS. 9 and 10) includes a second light-applying device 34E, which is an exemplary light-applying unit. The other details of the second exemplary embodiment are the same as those of the first exemplary embodiment.

As illustrated in FIG. 9, the second light-applying device 34E includes a light source 34E1 and plural (three, for example, in the second exemplary embodiment) mirrors 34E2. The light source 34E1 is an exemplary emitting unit. The mirrors 34E2 are exemplary changing units. As illustrated in FIGS. 9 and 10, the light source 34E1 is fixed to a surface of the table BD that is on the near side in the apparatus-depth direction. The light source 34E1 emits light upward in the apparatus-height direction. As illustrated in FIG. 9, the plural mirrors 34E2 are provided at the following positions, respectively: two positions (the position P1 and the position P5) each between a pair of shutters 40 provided on a corresponding one of the two ends in the apparatus-width direction, and one position (the position P3) between the first ejecting unit 22 and the second ejecting unit 24. As illustrated in FIG. 10, the mirrors 34E2 each have a mountain-like shape with a pointed top. As illustrated in FIGS. 9 and 10, the mirrors 34E2 are each oriented with the ridge thereof extending in the apparatus-width direction.

As illustrated in FIG. 10, in the second light-applying device 34E, light emitted from the light source 34E1 is reflected by any of the mirrors 34E2 and is thus redirected before falling onto and curing the droplets D ejected from the first ejecting unit 22 and the second ejecting unit 24 and landed on the table BD. Arrows L illustrated in FIG. 10 represent the paths of the light emitted from the light source 34E1 and redirected by the mirror 34E2.

A method of additively manufacturing an object M according to the second exemplary embodiment is the same as the method of additively manufacturing an object M according to the first exemplary embodiment, except that the second light-applying device 34E applies light to the droplets D on the table BD when the table BD is at any of the positions P1, P3, and P5.

### Functions

The additive manufacturing apparatus 10E according to the second exemplary embodiment differs from the additive manufacturing apparatus 10 according to the first exemplary embodiment (see FIG. 1) in that the moving device MA only needs to move the table BD. Hence, the configuration of the additive manufacturing apparatus 10E according to the second exemplary embodiment is simpler than in a case where the moving device MA moves not only the table BD but also the second light-applying device 34. The other functions exerted by the second exemplary embodiment are the same as those exerted by the first exemplary embodiment or the first modification.

### First Modification of Second Exemplary Embodiment (Fourth Modification)

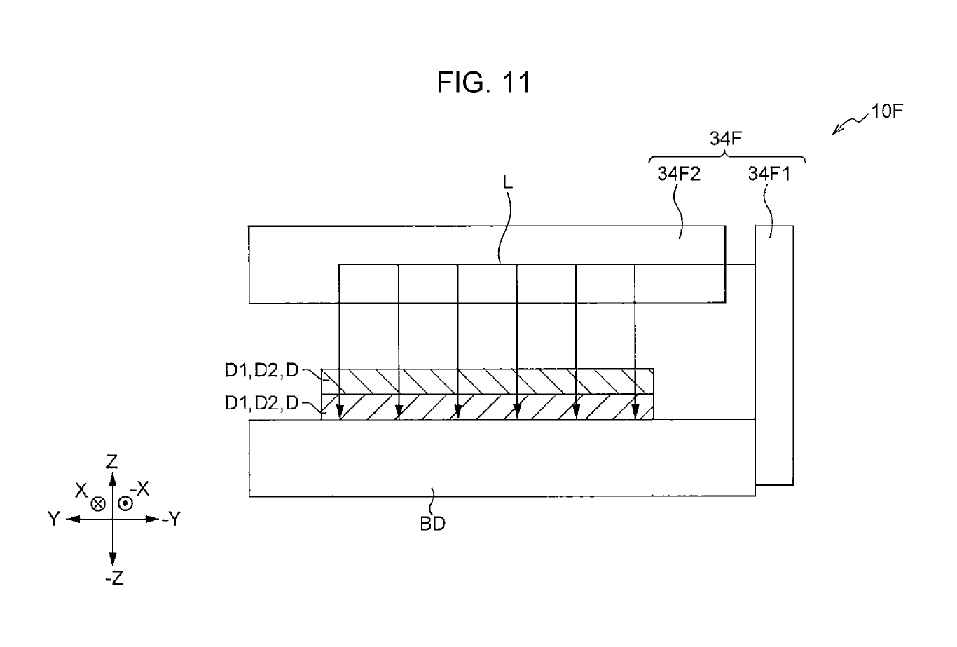

Now, an additive manufacturing apparatus 10F according to a fourth modification will be described with reference to FIG. 11. In the following description, any elements of the additive manufacturing apparatus 10F according to the fourth modification that are the same as those of the additive manufacturing apparatus 10 according to the first exemplary embodiment or the additive manufacturing apparatuses 10E according to the second exemplary embodiment are denoted by corresponding ones of the reference numerals used for the additive manufacturing apparatus 10 or 10E, whether they are illustrated or not.

### Configuration of Additive Manufacturing Apparatus and Method of Additively Manufacturing Object

The additive manufacturing apparatus 10F according to the fourth modification (see FIG. 11) includes a second light-applying device 34F in replacement of the second light-applying device 34E included in the additive manufacturing apparatus 10E according to the second exemplary embodiment (see FIG. 10). The second light-applying device 34F is an exemplary light-applying unit. The other details of the fourth modification are the same as those of the second exemplary embodiment.

The second light-applying device 34F includes a light source 34F1 and plural (three, for example, in the fourth modification) light-guiding plates 34F2. The light source 34F1 is an exemplary emitting unit. The light-guiding plates 34F2 are exemplary changing units. The light source 34F1 has a long shape, with one long-side end thereof fixed to a surface of the table BD that is on the near side in the apparatus-depth direction. The light source 34F1 emits light in the apparatus-depth direction from the other long-side end thereof. The plural light-guiding plates 34F2 illustrated in FIG. 11 are provided at the following positions, respectively: two positions (the position P1 and the position P5) each between a pair of shutters 40 provided on a corresponding one of the two ends in the apparatus-width direction, and one position (the position P3) between the first ejecting unit 22 and the second ejecting unit 24.

As illustrated in FIG. 11, in the second light-applying device 34F, light emitted from the light source 34F1 is incident on any of the light-guiding plates 34F2 and is redirected by that light-guiding plate 34F2 (the direction of travel of the light is changed from the apparatus-depth direction to the apparatus-height direction) before falling onto and curing the droplets D ejected from the first ejecting unit 22 and the second ejecting unit 24 and landed on the table BD. Arrows L illustrated in FIG. 11 represent the paths of the light emitted from the light source 34F1 and redirected by the light-guiding plate 34F2.

### Functions

Functions exerted by the fourth modification are the same as those exerted by any of the first exemplary embodiment, the first modification, and the second exemplary embodiment.

### Second Modification of Second Exemplary Embodiment (Fifth Modification)

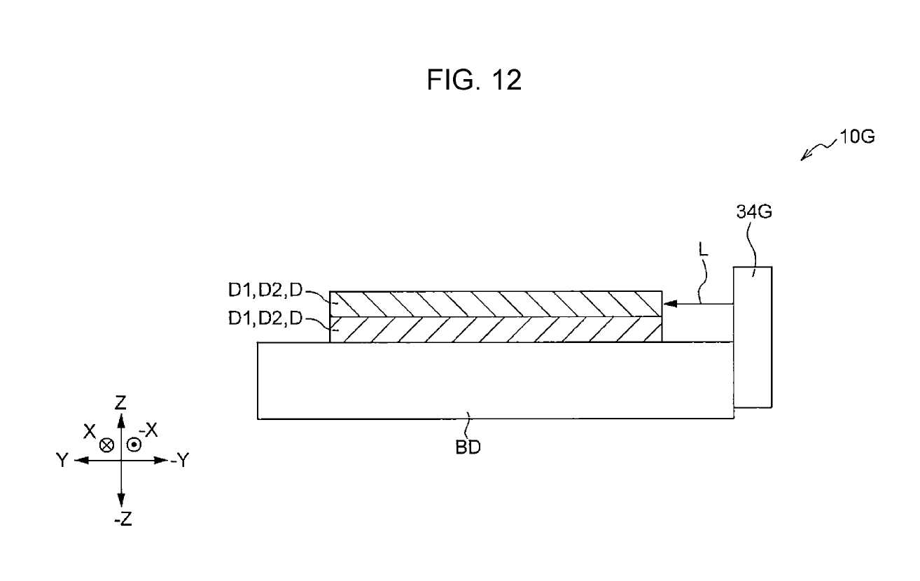

Now, an additive manufacturing apparatus 10G according to a fifth modification will be described with reference to FIG. 12. In the following description, any elements of the additive manufacturing apparatus 10G according to the fifth modification that are the same as those of the additive manufacturing apparatus 10 according to the first exemplary embodiment, the additive manufacturing apparatus 10E according to the second exemplary embodiment, or the additive manufacturing apparatus 10F according to the fourth modification are denoted by corresponding ones of the reference numerals used for any of the additive manufacturing apparatuses 10, 10E, and 10F, whether they are illustrated or not.

### Configuration of Additive Manufacturing Apparatus and Method of Additively Manufacturing Object

The additive manufacturing apparatus 10G according to the fifth modification (see FIG. 12) includes a second light-applying device 34G in replacement of the second light-applying device 34F included in the additive manufacturing apparatus 10F according to the fourth modification (see FIG. 11). The second light-applying device 34G is an exemplary light-applying unit. The other details of the fifth modification are the same as those of the fourth modification.

The second light-applying device 34G has a long shape, with one long-side end thereof fixed to a surface of the table BD that is on the near side in the apparatus-depth direction. The second light-applying device 34G is a light source that emits light in the apparatus-depth direction from the other long-side end thereof. When the second light-applying device 34G is at any of the positions P1, P3, and P5, the second light-applying device 34G applies light to the droplets D ejected from the first ejecting unit 22 and the second ejecting unit 24 and landed on the table BD and thus cures the droplets D. Arrow L illustrated in FIG. 12 represents the path of the light emitted from the second light-applying device 34G.

### Functions

Functions exerted by the fifth modification are the same as those exerted by any of the first exemplary embodiment, the first modification, the second exemplary embodiment, and the fourth modification.

### Third Modification of Second Exemplary Embodiment (Sixth Modification)

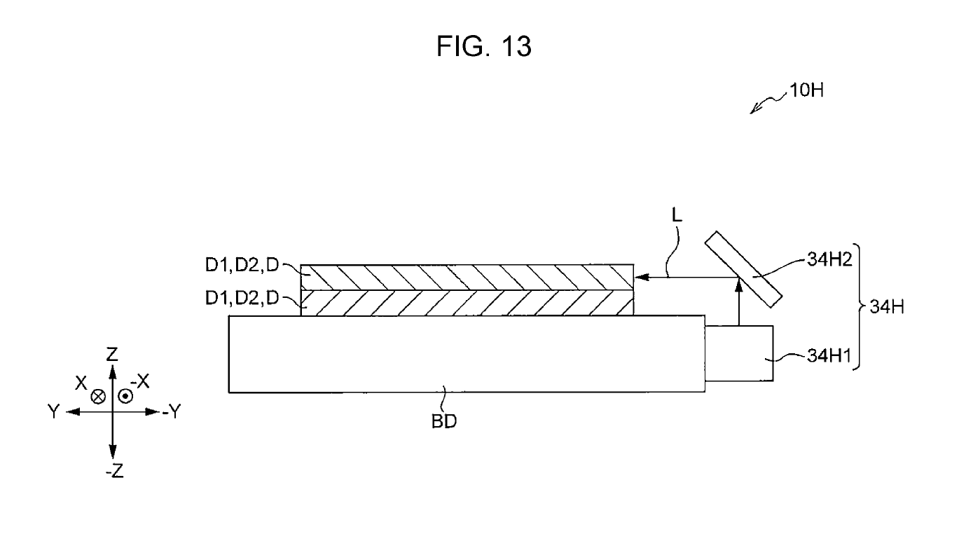

Now, an additive manufacturing apparatus 10H according to a sixth modification will be described with reference to FIG. 13. In the following description, any elements of the additive manufacturing apparatus 10H according to the sixth modification that are the same as those of the additive manufacturing apparatus 10 according to the first exemplary embodiment, the additive manufacturing apparatus 10E according to the second exemplary embodiment, or the additive manufacturing apparatus 10F according to the fourth modification are denoted by corresponding ones of the reference numerals used for any of the additive manufacturing apparatuses 10, 10E, and 10F, whether they are illustrated or not.

### Configuration of Additive Manufacturing Apparatus and Method of Additively Manufacturing Object

The additive manufacturing apparatus 10H according to the sixth modification (see FIG. 13) includes a second light-applying device 34H in replacement of the second light-applying device 34E included in the additive manufacturing apparatus 10E according to the second exemplary embodiment (see FIG. 10). The second light-applying device 34H is an exemplary light-applying unit. The other details of the sixth modification are the same as those of the second exemplary embodiment.

The second light-applying device 34H includes a light source 34H1 and plural (three, for example, in the sixth modification) mirrors 34H2. The light source 34H1 is an exemplary emitting unit. The mirrors 34H2 are exemplary changing units. The light source 34H1 is fixed to a surface of the table BD that is on the near side in the apparatus-depth direction and emits light in the apparatus-height direction. As illustrated in FIG. 13, the mirrors 34H2 are each provided at a corresponding one of positions above the light source 34H1 in the apparatus-height direction and reflect the light emitted from the light source 34H1 and being incident thereon toward the far side in the apparatus-width direction. Hence, in the second light-applying device 34H illustrated in FIG. 13, light emitted from the light source 34H1 is incident on any of the mirrors 34H2 and is redirected by that mirror 34H2 (the direction of travel of the light is changed from the apparatus-height direction to the apparatus-depth direction) before falling onto and curing the droplets D ejected from the first ejecting unit 22 and the second ejecting unit 24 and landed on the table BD. Arrows L illustrated in FIG. 13 represent the paths of the light emitted from the light source 34H1 and redirected by the mirror 34H2.

### Functions

Functions exerted by the sixth modification are the same as those exerted by the first exemplary embodiment, the first modification, or the second exemplary embodiment.

### Fourth Modification of Second Exemplary Embodiment (Seventh Modification)

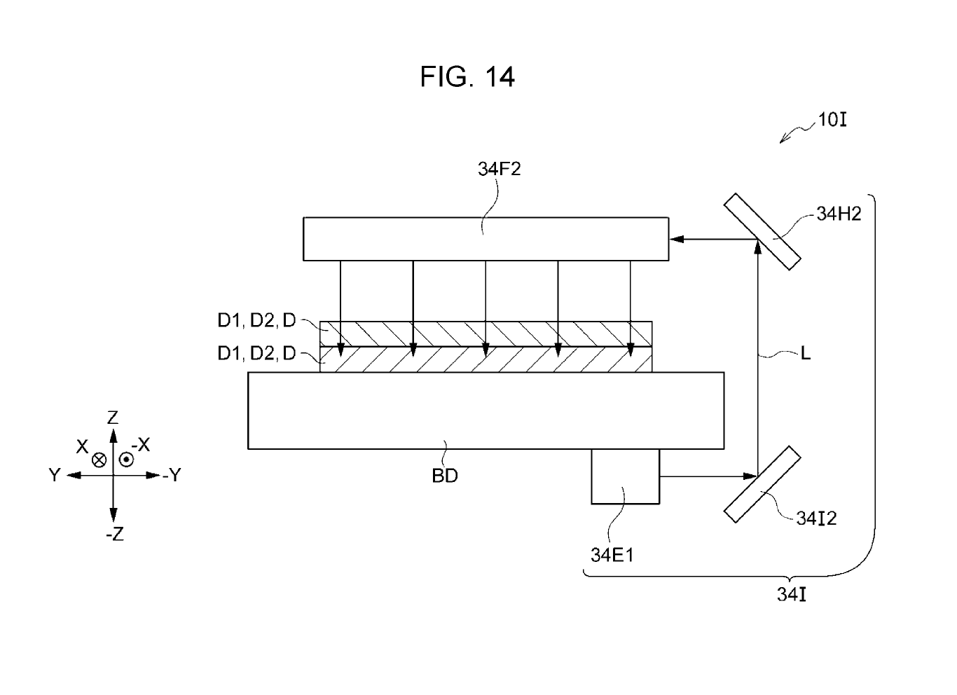

Now, an additive manufacturing apparatus 10I according to a seventh modification will be described with reference to FIG. 14. In the following description, any elements of the additive manufacturing apparatus 10I according to the seventh modification that are the same as those of the additive manufacturing apparatus 10 according to the first exemplary embodiment, the additive manufacturing apparatus 10E according to the second exemplary embodiment, the additive manufacturing apparatus 10F according to the fourth modification, or the additive manufacturing apparatus 10H according to the sixth modification are denoted by corresponding ones of the reference numerals used for any of the additive manufacturing apparatuses 10, 10E, 10F, and 10H, whether they are illustrated or not.

### Configuration of Additive Manufacturing Apparatus and Method of Additively Manufacturing Object

The additive manufacturing apparatus 10I according to the seventh modification (see FIG. 14) includes a second light-applying device 34I in replacement of the second light-applying device 34E included in the additive manufacturing apparatus 10E according to the second exemplary embodiment (see FIG. 10). The second light-applying device 34I is an exemplary light-applying unit. The other details of the seventh modification are the same as those of the second exemplary embodiment.

The second light-applying device 34I includes a light source 34E1, plural mirrors 34I2, plural mirrors 34H2, and plural light-guiding plates 34F2 (in the seventh modification, three mirrors 34I2, three mirrors 34H2, and three light-guiding plates 34F2 are provided, for example). The light source 34E1 is an exemplary emitting unit. A combination of one mirror 34I2 and one mirror 34H2 is an exemplary changing unit.

The light source 34E1 is fixed to the lower surface of the table BD, with the long-side direction thereof corresponding to the apparatus-width direction. The light source 34E1 emits light toward the near side in the apparatus-depth direction. A combination of one mirror 34I2, one mirror 34H2, and one light-guiding plate 34F2 is provided at each of the positions P1, P3, and P5 in the apparatus-width direction. The mirrors 34I2 are provided on the near side with respect to the light source 34E1 in the apparatus-depth direction and reflect the light from the light source 34E1 upward in the apparatus-height direction. The mirrors 34H2 are provided on the upper side with respect to the mirrors 34I2 in the apparatus-height direction and reflect the light from the mirrors 34I2 toward the far side in the apparatus-depth direction. The light-guiding plates 34F2 are provided on the upper side with respect to the table BD in the apparatus-height direction and on the far side with respect to the mirrors 34H2 in the apparatus-depth direction. The light-guiding plates 34F2 redirect the light reflected by the mirrors 34H2 (the direction of travel of the light is changed from the apparatus-depth direction to the apparatus-height direction).

Hence, in the second light-applying device 34I illustrated in FIG. 14, light emitted from the light source 34E1 is incident on one of the mirrors 34I2 and on one of the mirrors 34H2 and is redirected (the direction of travel of the light is changed from the apparatus-depth direction to the apparatus-height direction) before falling onto and curing the droplets D ejected from the first ejecting unit 22 and the second ejecting unit 24 and landed on the table BD. Arrows L illustrated in FIG. 14 represent the paths of the light emitted from the light source 34E1 and redirected by the mirrors 34I2 and 34H2 and by the light-guiding plate 34F2.

### Functions

Functions exerted by the seventh modification are the same as those exerted by any of the first exemplary embodiment, the first modification, and the second exemplary embodiment.

### Fifth Modification of Second Exemplary Embodiment (Eighth Modification)

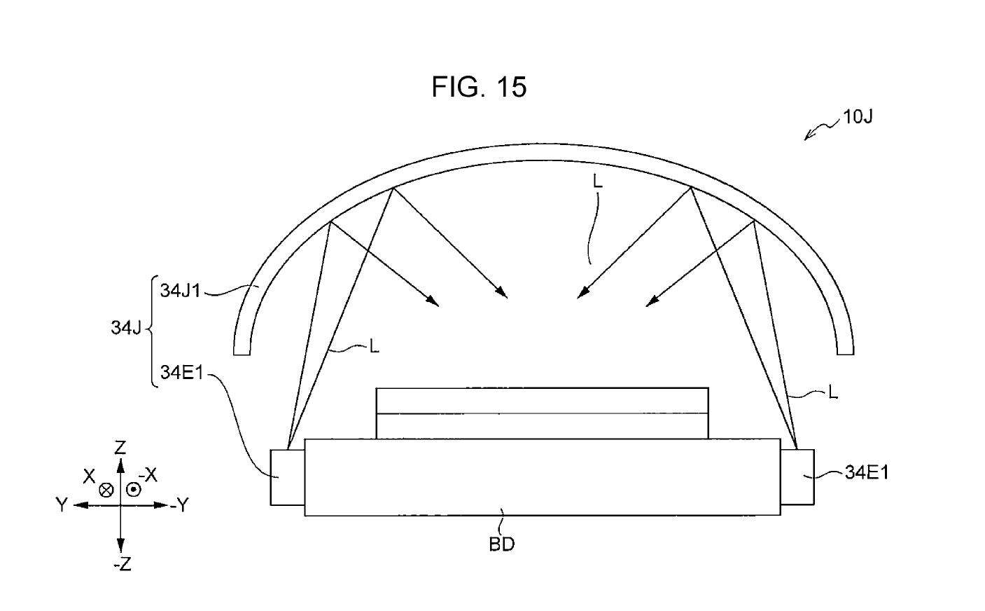

Now, an additive manufacturing apparatus 10J according to an eighth modification will be described with reference to FIG. 15. In the following description, any elements of the additive manufacturing apparatus 10J according to the eighth modification that are the same as those of the additive manufacturing apparatus 10 according to the first exemplary embodiment, the additive manufacturing apparatus 10E according to the second exemplary embodiment, the additive manufacturing apparatus 10F according to the fourth modification, or the additive manufacturing apparatus 10H according to the sixth modification are denoted by corresponding ones of the reference numerals used for any of the additive manufacturing apparatuses 10, 10E, 10F, and 10H, whether they are illustrated or not.

### Configuration of Additive Manufacturing Apparatus and Method of Additively Manufacturing Object

The additive manufacturing apparatus 10J according to the eighth modification (see FIG. 15) includes a second light-applying device 34J in replacement of the second light-applying device 34E included in the additive manufacturing apparatus 10E according to the second exemplary embodiment (see FIG. 10). The second light-applying device 34J is an exemplary light-applying unit. The other details of the eighth modification are the same as those of the second exemplary embodiment.

The second light-applying device 34J includes plural (two, for example, in the eighth modification) light sources 34E1 and plural (three, for example, in the eighth modification) curved mirrors 34J1. The light sources 34E1 are exemplary emitting units. The curved mirrors 34J1 are exemplary changing units.

The light sources 34E1 are fixed to side surfaces of the table BD that are on the near side and the far side, respectively, in the apparatus-depth direction, with the long-side direction thereof corresponding to the apparatus-width direction. The light sources 34E1 emit light upward in the apparatus-height direction. The curved mirrors 34J1 are provided, with the concave side thereof facing downward in the apparatus-height direction, at the respective positions P1, P3, and P5 in the apparatus-width direction and on the upper side with respect to the table BD in the apparatus-height direction. The curved mirrors 34J1 each reflect the light from the light sources 34E1 toward the table BD (the direction of travel of the light is changed).

Hence, in the second light-applying device 34J illustrated in FIG. 15, light emitted from each of the light sources 34E1 is incident on any of the curved mirrors 34J1 and is redirected before falling onto and curing the droplets D ejected from the first ejecting unit 22 and the second ejecting unit 24 and landed on the table BD. Arrows L illustrated in FIG. 15 represent the paths of the light emitted from the light sources 34E1 and redirected by the curved mirror 34J1.

The curved mirrors 34J1 each also reduce the quantity of light traveling toward the plural nozzles N after being emitted from the light sources 34E1 and reflected by the droplets D.

### Functions

Functions exerted by the eighth modification are the same as those exerted by any of the first exemplary embodiment, the first modification, and the second exemplary embodiment.

While specific exemplary embodiments of the present invention have been described in detail, the present invention is not limited to such exemplary embodiments. Various other exemplary embodiments are conceivable within the scope of the present invention.

For example, while the above exemplary embodiments each concern a case where the table BD moves back and forth relative to the ejecting device 20, the ejecting device 20 may move back and forth relative to the table BD.

While the above exemplary embodiments each concern a case where the first ejecting unit 22 and the second ejecting unit 24 each include the first head 22A and the second head 22B, the first head 22A ejecting droplets D composed of the model material, the second head 22B ejecting droplets D composed of the support material. Note that, as described above, the support material forms, if necessary, a three-dimensional object VM together with the model material in the process of manufacturing an object M but does not form the object M. Hence, in each of the additive manufacturing apparatuses 10, 10B, 10C, 10D, 10E, 10F, 10G, 10H, 10I, and 10J, the second head 22B included in each of the first ejecting unit 22 and the second ejecting unit 24 may be omitted.

In addition, while the above exemplary embodiments and the modifications thereof each concern a case where the ejecting device 20 includes the first ejecting unit 22 and the second ejecting unit 24, i.e., two ejecting units (see FIG. 1 and others), the number of ejecting units included in the ejecting device 20 is not limited to two. For example, the ejecting device 20 may include one ejecting unit or three or more ejecting units.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An additive manufacturing apparatus comprising:
a table;
an ejecting unit that faces the table and ejects photocurable droplets toward the table;
a light-applying unit that applies light to and cures the droplets ejected from the ejecting unit and landed on the table;
a moving unit that moves the table back and forth along with the light-applying unit and relative to the ejecting unit; and
a controller that controls the ejecting unit, the light-applying unit, and the moving unit such that the ejecting unit ejects droplets and makes the droplets land on the table while the table is moved relative to the ejecting unit; the light-applying unit applies, when a direction of relative movement of the table is changed, light to the droplets that have moved together with the table out of an area where the table faces the ejecting unit; and a three-dimensional object is formed as a stack of layers composed of the droplets that have been cured.

2. The additive manufacturing apparatus according to claim 1,
wherein the ejecting unit has an ejection port from which the droplets are ejected, and
wherein the additive manufacturing apparatus further includes a reducing wall provided on a side of the ejecting unit toward which the light from the light-applying unit is applied, the reducing wall reducing a quantity of light traveling toward the ejection port after being applied to and reflected by the droplets.

3. The additive manufacturing apparatus according to claim 1,
wherein the light-applying unit is provided across the ejecting unit from the table in a facing direction in which the table and the ejecting unit face each other, and
wherein the additive manufacturing apparatus further includes a blocking member that blocks the light emitted from the light-applying unit, the blocking member being provided between the ejecting unit and the light-applying unit in the facing direction and extending over a coinciding area that covers the ejecting unit when seen at least in the facing direction.

4. The additive manufacturing apparatus according to claim 2,
wherein the light-applying unit is provided across the ejecting unit from the table in a facing direction in which the table and the ejecting unit face each other, and
wherein the additive manufacturing apparatus further includes a blocking member that blocks the light emitted from the light-applying unit, the blocking member being provided between the ejecting unit and the light-applying unit in the facing direction and extending over a coinciding area that covers the ejecting unit when seen at least in the facing direction.

5. The additive manufacturing apparatus according to claim 3,
wherein the ejecting unit is one of a plurality of ejecting units that are arranged side by side at intervals in the direction of relative movement of the table, and
wherein the blocking member extends continuously from a position facing one of the ejecting units that is provided at one end in the direction of relative movement to a position facing another one of the ejecting units that is provided at an other end in the direction of relative movement, the blocking member having a through hole in a region excluding the coinciding area.

6. The additive manufacturing apparatus according to claim 5, wherein the blocking member is provided with a focusing body fitted in the through hole, the focusing body focusing the light emitted from the light-applying unit on a side of the focusing body where the table is provided.

7. An additive manufacturing apparatus comprising:
a table;
an ejecting unit that faces the table and ejects photocurable droplets toward the table;
a light-applying unit including an emitting unit that emits light and a changing unit that changes a direction of travel of the light emitted from the emitting unit, the light-applying unit applying, while the direction of travel of the light emitted from the emitting unit is changed by the changing unit, light to and curing the droplets ejected from the ejecting unit and landed on the table;
a moving unit that moves the table back and forth along with the emitting unit and relative to the ejecting unit; and
a controller that controls the ejecting unit, the emitting unit, and the moving unit such that the ejecting unit ejects droplets and makes the droplets land on the table while the table is moved relative to the ejecting unit; the light-applying unit applies, when a direction of relative movement of the table is changed, light to the droplets that have moved together with the table out of an area where the table faces the ejecting unit; and a three-dimensional object is formed as a stack of layers composed of the droplets that have been cured.
